(19) United States
(12) Patent Application Publication
(10) Pub. No.: US 2006/0070184 A1
(43) Pub. Date: Apr. 6, 2006

(54) Portable air inflatable device

(75) Inventor: Ping-Ting Lin, Long Ching Hsiang (TW)

Correspondence Address: NIKOLAI & MERSEREAU, P.A., 900 SECOND AVENUE SOUTH, SUITE 820, MINNEAPOLIS, MN, 55402, US

(73) Assignee: Feng Yi Outdoor Leisure Equipment Enterprise Co., Ltd., Taichung Hsien (TW)

(21) Appl. No.: 10/951,110

(22) Filed: Sep. 27, 2004

(51) Int. Cl. A61G 7/057

(52) U.S. Cl. 5/689

(57) ABSTRACT

An air inflatable device includes an inflatable body having an upper surface layer and a lower surface layer, a sponge layer mounted between the upper surface layer and the lower surface layer of the inflatable body, an air inlet valve mounted between the upper surface layer and the sponge layer, and a oneway valve mounted on a side of the inflatable body and connected to the sponge layer. Thus, the air inflatable device is used to inflate an object easily and conveniently, thereby facilitating a user inflating the object.

### BACKGROUND OF THE INVENTION

1. Field of the Invention

The present invention relates to an air inflatable device (cushion or bag), and more particularly to a portable air inflatable device to facilitate a user carrying the air inflatable device.

2. Description of the Related Art

A conventional air inflatable article, such as an air inflatable cushion, bag, rubber swim ring, rubber swim pool or the like, is expanded by blowing air into the air inflatable article for use with a user. However, the user has to inflate the air inflatable article by an inflator, thereby causing inconvenience to the user. In addition, the user has to inflate the air inflatable article by his mouth when the inflator is not prepared, thereby causing a sanitary problem.

### SUMMARY OF THE INVENTION

In accordance with the present invention, there is provided an air inflatable device, comprising:

an inflatable body having an upper surface layer and a lower surface layer;

a sponge layer mounted between the upper surface layer and the lower surface layer of the inflatable body;

an air inlet valve mounted between the upper surface layer and the sponge layer; and

a oneway valve mounted on a side of the inflatable body and connected to the sponge layer.

The primary objective of the present invention is to provide a portable air inflatable device to facilitate a user carrying the air inflatable device.

Another objective of the present invention is to provide an air inflatable device, wherein the upper surface layer of the inflatable body is pressed and released successively so as to inflate an object, so that the air inflatable device is used to inflate the object easily and conveniently, thereby facilitating a user inflating the object.

A further objective of the present invention is to provide an air inflatable device, wherein the inflatable body is inflated automatically by the restoring action of the sponge layer, so that the air inflatable device can function as a pillow.

A further objective of the present invention is to provide an air inflatable device, wherein when the air inflatable device is not in use, the air contained in the sponge layer is compressed outward, so that the volume of the air inflatable device is reduced to the minimum, thereby facilitating storage of the air inflatable device.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an air inflatable device in accordance with the preferred embodiment of the present invention;

FIG. 2 is a plan cross-sectional assembly view of the air inflatable device as shown in FIG. 1;

FIG. 3 is a schematic operational view of the air inflatable device as shown in FIG. 2 in use;

FIG. 4 is a partially enlarged view of the air inflatable device as shown in FIG. 3;

FIG. 5 is a schematic operational view of the air inflatable device as shown in FIG. 1 in use;

FIG. 6 is an exploded perspective view of an air inflatable device in accordance with another embodiment of the present invention; and

FIG. 7 is a perspective view of an air inflatable device in accordance with another embodiment of the present invention.

### DETAILED DESCRIPTION OF THE INVENTION

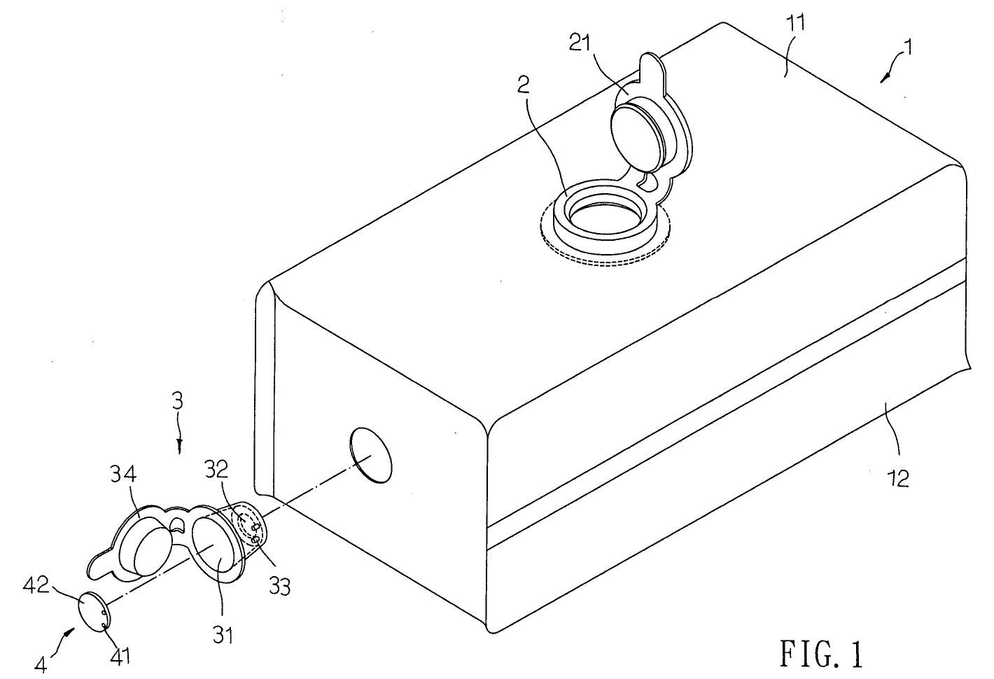

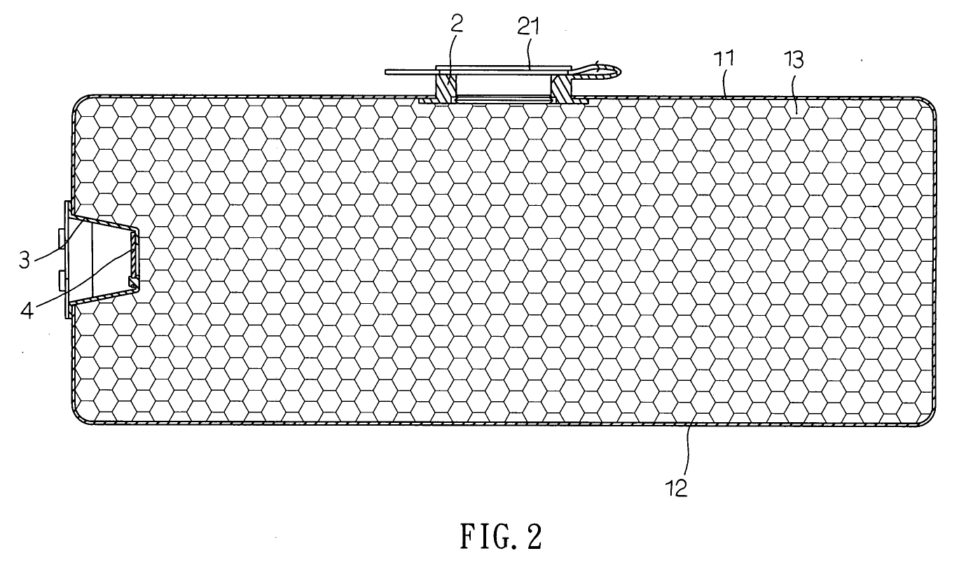

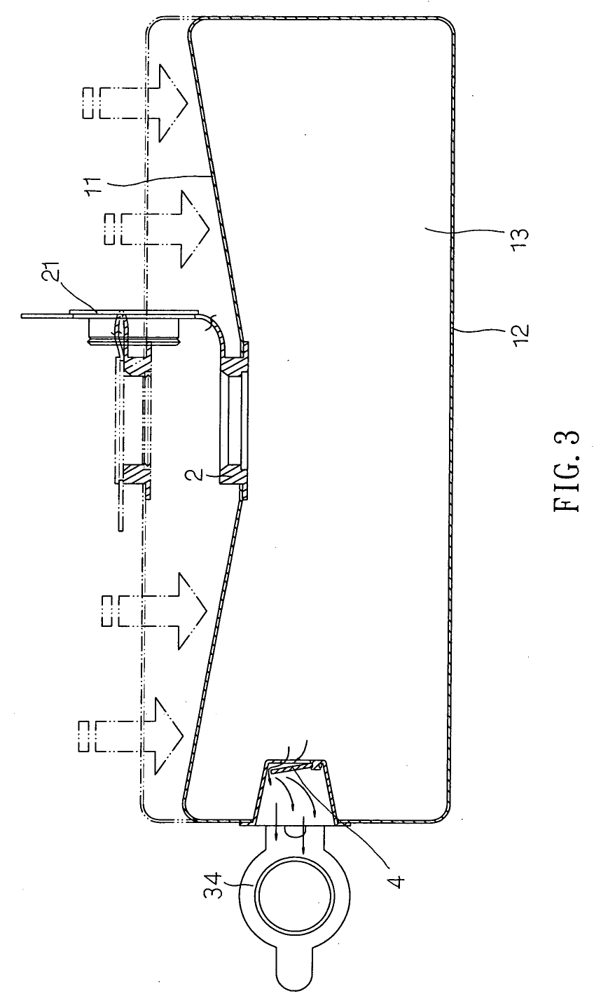

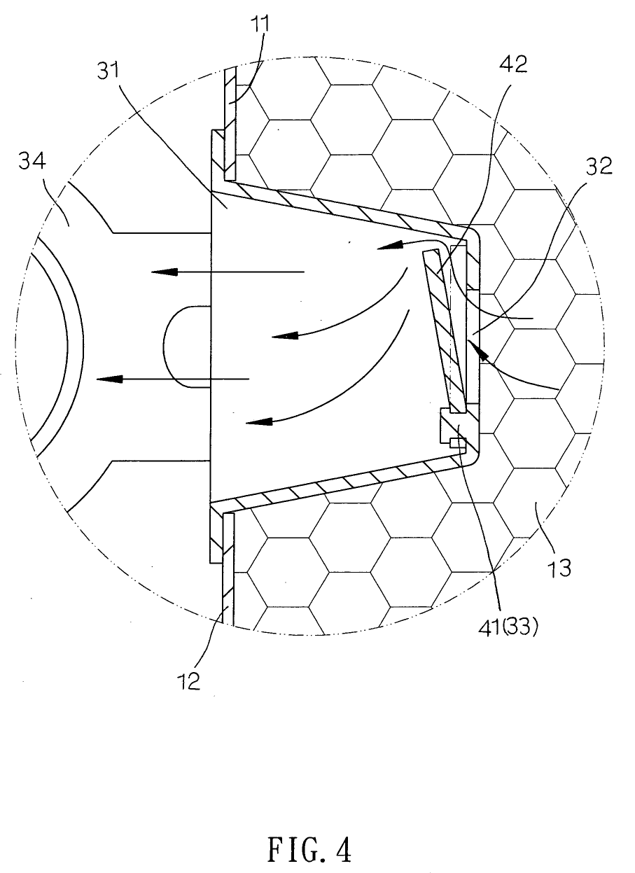

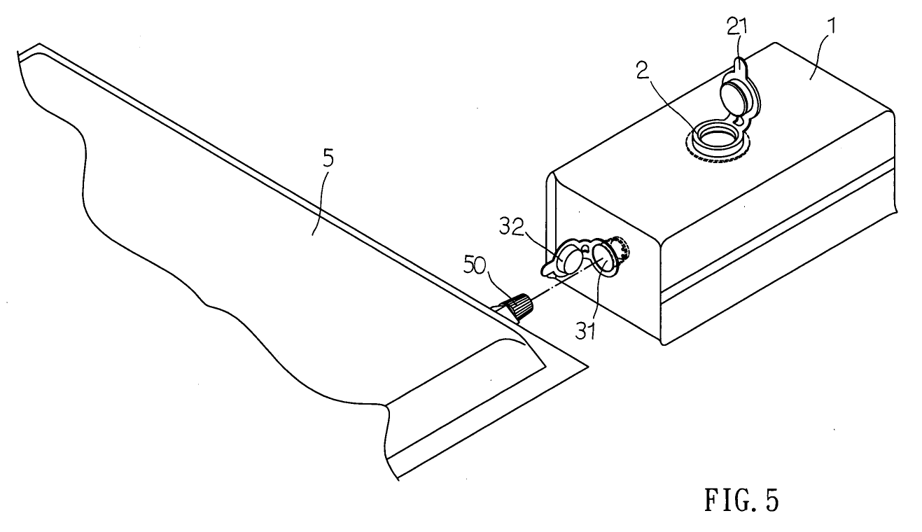

Referring to the drawings and initially to FIGS. 1-5, an air inflatable device in accordance with the preferred embodiment of the present invention comprises an inflatable body 1 having an upper surface layer 11 and a lower surface layer 12, a sponge layer 13 mounted between the upper surface layer 11 and the lower surface layer 12 of the inflatable body 1, an air inlet valve 2 mounted between the upper surface layer 11 and the sponge layer 13, and a oneway valve 3 mounted on a side of the inflatable body 1 and connected to the sponge layer 13.

The upper surface layer 11 and the lower surface layer 12 of the inflatable body 1 are air impermeable and are combined with each other by high frequency waves. The air inlet valve 2 has a periphery provided with a seal cover 21.

The oneway valve 3 is combined with the inflatable body 1 by high frequency waves. The oneway valve 3 includes a cup-shaped connector 31 inserted into the inflatable body 1 and having an end face formed with a circular through hole 32 connected to an inside of the sponge layer 13, and a circular control plate 4 mounted in the connector 31 and pivotally mounted on the end face of the connector 31 to cover the through hole 32 of the connector 31. The connector 31 has a periphery provided with a seal cover 34.

The control plate 4 is made of flexible material, such as silicon, plastic or the like, and has a first side secured on a first side of the through hole 32 of the connector 31 and a second side formed with a free end 42 detachably rested on a second side of the through hole 32 of the connector 31. The first side of the through hole 32 of the connector 31 is formed with a protruding locking tenon 33, and the first side of the control plate 4 is formed with a locking hole 41 locked on the locking tenon 33 of the connector 31.

In operation, when a user wishes to inflate an object, such as an air cushion 5, the seal cover 21 of the air inlet valve 2 and the seal cover 34 of the oneway valve 3 are opened respectively. Then, the air nozzle 50 of the air cushion 5 is inserted into the connector 31 of the oneway valve 3. Then, the upper surface layer 11 of the inflatable body 1 is pressed downward toward the lower surface layer 12 to compress the sponge layer 13 so as to push the air contained in the sponge layer 13 to flow through the through hole 32 of the connector 31 into the connector 31 of the oneway valve 3 and then flow through the air nozzle 50 of the air cushion 5 into the air cushion 5.

At this time, when the air passes through the through hole 32 of the connector 31, the free end 42 of the control plate 4 is pushed away by the compressed air, so that the air flows through the through hole 32 of the connector 31 into the connector 31 of the oneway valve 3 smoothly. When the air is pushed to flow backward, the free end 42 of the control plate 4 is pushed backward to seal the through hole 32 of the connector 31 completely to interrupt the air flow, thereby preventing the air from flowing backward. In such a manner, the air flows through the through hole 32 of the connector 31 into the connector 31 of the oneway valve 3 and cannot flow backward.

After the pressing force applied on the upper surface layer 11 of the inflatable body 1 is removed, the upper surface layer 11 of the inflatable body 1 is expanded and restored to its original state by the restoring force the sponge layer 13 to introduce the ambient air through the air inlet valve 2 into the sponge layer 13, so that the inflatable body 1 is inflated automatically by the sponge layer 13.

In such a manner, the upper surface layer 11 of the inflatable body 1 is pressed and released successively, and the above-mentioned procedures are repeated successively, so that the air contained in the sponge layer 13 in turn flows through the through hole 32 of the connector 31 into the connector 31 of the oneway valve 3 and then flows through the air nozzle 50 of the air cushion 5 into the air cushion 5 so as to inflate the air cushion 5.

In addition, the inflatable body 1 is inflated automatically by the sponge layer 13, so that the air inflatable device can function as a pillow.

In addition, when the air inflatable device is not in use, the air contained in the sponge layer 13 is compressed outward, and the seal cover 21 of the air inlet valve 2 and the seal cover 34 of the oneway valve 3 are closed respectively so as to fold the air inflatable device, so that the volume of the air inflatable device is reduced to the minimum, thereby facilitating storage of the air inflatable device.

Accordingly, the upper surface layer 11 of the inflatable body 1 is pressed and released successively so as to inflate an object, so that the air inflatable device is used to inflate the object easily and conveniently, thereby facilitating a user inflating the object. In addition, the inflatable body 1 is inflated automatically by the restoring action of the sponge layer 13, so that the air inflatable device can function as a pillow. Further, when the air inflatable device is not in use, the air contained in the sponge layer 13 is compressed outward, so that the volume of the air inflatable device is reduced to the minimum, thereby facilitating storage of the air inflatable device.

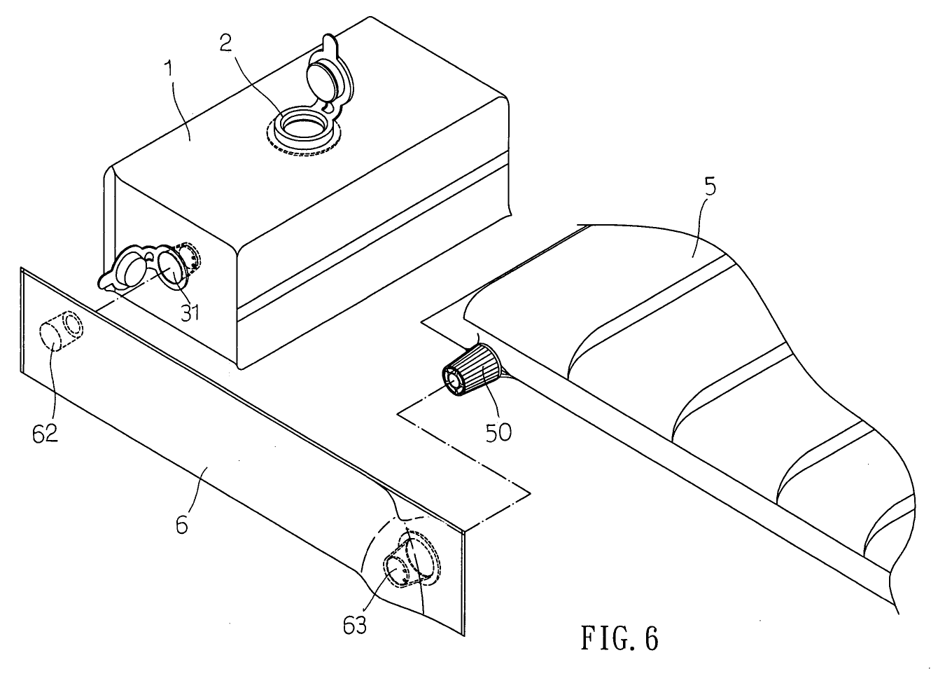

Referring to FIG. 6, the air inflatable device further comprises a connecting bag 6 mounted between the inflatable body 1 and the air cushion 5 and having a first end provided with an air inlet valve 62 mounted on the connector 31 of the oneway valve 3 and a second end provided with a secondary oneway valve 63 mounted on the air nozzle 50 of the air cushion 5. Thus, the connecting bag 6 functions as an adapter to connect the connector 31 of the inflatable body 1 to the air cushion 5. Thus, the air contained in the sponge layer 13 of the inflatable body 1 in turn flows through the through hole 32 of the connector 31 into the connector 31 of the oneway valve 3, then flows through the air inlet valve 62, the inside of the connecting bag 6 and the secondary oneway valve 63, and then flows through the air nozzle 50 of the air cushion 5 into the air cushion 5 so as to inflate the air cushion 5.

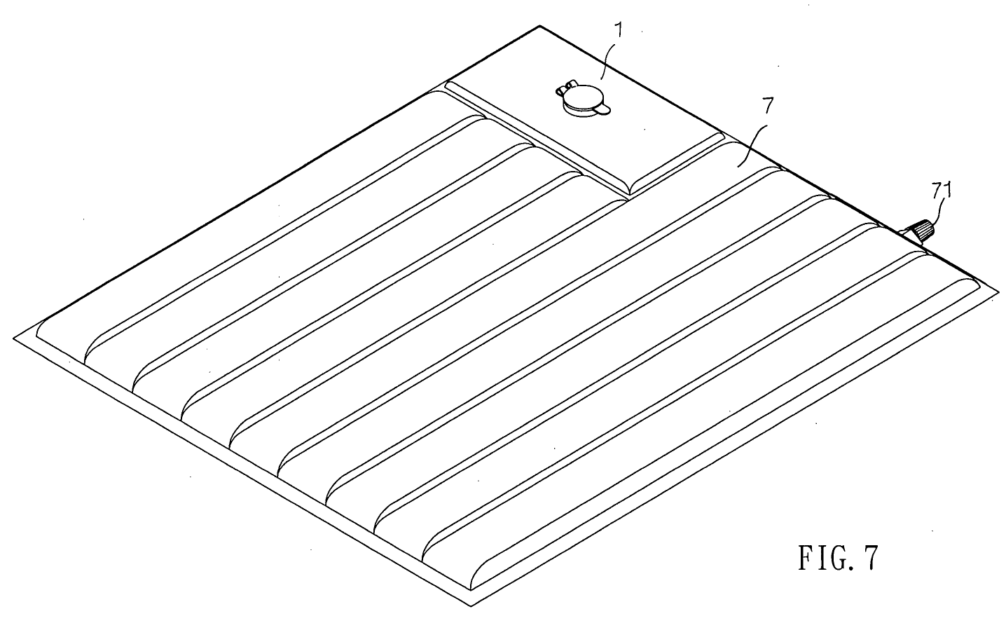

Referring to FIG. 7, the inflatable body 1 is integrally combined with an air inflatable cushion 7 having an air nozzle 71, and the oneway valve 3 is hidden in and connected to an inside of the air inflatable cushion 7.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An air inflatable device, comprising:
an inflatable body having an upper surface layer and a lower surface layer;
a sponge layer mounted between the upper surface layer and the lower surface layer of the inflatable body;
an air inlet valve mounted between the upper surface layer and the sponge layer; and
a oneway valve mounted on a side of the inflatable body and connected to the sponge layer.

2. The air inflatable device in accordance with claim 1, wherein the upper surface layer and the lower surface layer of the inflatable body are combined with each other.

3. The air inflatable device in accordance with claim 1, wherein the air inlet valve has a periphery provided with a seal cover.

4. The air inflatable device in accordance with claim 1, wherein the oneway valve is combined with the inflatable body by high frequency waves.

5. The air inflatable device in accordance with claim 1, wherein the oneway valve includes a connector inserted into the inflatable body and having an end face formed with a through hole connected to an inside of the sponge layer, and a control plate mounted in the connector and pivotally mounted on the end face of the connector to cover the through hole of the connector.

6. The air inflatable device in accordance with claim 5, wherein the control plate has a first side secured on a first side of the through hole of the connector and a second side formed with a free end detachably rested on a second side of the through hole of the connector.

7. The air inflatable device in accordance with claim 6, wherein the first side of the through hole of the connector is formed with a protruding locking tenon, and the first side of the control plate is formed with a locking hole locked on the locking tenon of the connector.

8. The air inflatable device in accordance with claim 5, wherein the connector has a periphery provided with a seal cover.

9. The air inflatable device in accordance with claim 5, wherein the connector is substantially cup-shaped.

10. The air inflatable device in accordance with claim 5, wherein the through hole of the connector has a circular shape.

11. The air inflatable device in accordance with claim 5, wherein the control plate has a circular shape.

12. The air inflatable device in accordance with claim 5, wherein the control plate is made of silicon.

13. The air inflatable device in accordance with claim 5, wherein the control plate is made of plastic material.

14. The air inflatable device in accordance with claim 5, further comprising an air cushion having air nozzle inserted into the connector of the oneway valve.

15. The air inflatable device in accordance with claim 5, wherein the further comprising a connecting bag mounted between the inflatable body and an air cushion and having a first end provided with an air inlet valve mounted on the connector of the oneway valve and a second end provided with a secondary oneway valve mounted on an air nozzle of the air cushion.

16. The air inflatable device in accordance with claim 1, wherein the inflatable body is integrally combined with an air inflatable cushion having an air nozzle, and the oneway valve is hidden in and connected to an inside of the air inflatable cushion.
